(19) United States
(12) Patent Application Publication
(10) Pub. No.: US 2015/0314661 A1
(43) Pub. Date: Nov. 5, 2015

(54) Method And Device For A Cable Attachment At Vehicles

(71) Applicants: Thomas Erdtman, Santa Pola (Alicante) (ES); Mikael Johnson, Surahammar (SE)

(72) Inventors: Thomas Erdtman, Santa Pola (Alicante) (ES); Mikael Johnson, Surahammar (SE)

(73) Assignee: Truck Gears Sweden AB, Kolback (SE)

(21) Appl. No.: 13/819,758

(22) PCT Filed: Sep. 1, 2010
(86) PCT No.: PCT/SE2010/050931

§ 371 Date: May 23, 2013

(51) Int. Cl. B60D 1/62; H02G 3/30; H02G 1/06; B60R 16/02; F16L 3/04

(52) U.S. Cl. CPC B60D 1/62; B60R 16/0215; F16L 3/04; H02G 1/06; H02G 3/30

(57) ABSTRACT

The present invention relates to a device and a method, respectively, for the attachment of cabling at a traction vehicle, which traction vehicle (5) comprises at least one junction box (7) for the connection of the cabling (8) to a trailer (6), or the like, which method comprises that a holding device (1) is arranged to position the cabling at a distance above surfaces (50) situated below the cabling (8), characterized in that said holding device (1) is attached to said traction vehicle (5) by means of non-destructive means (3), wherein said non-destructive means (3) are arranged to give a retaining force of 100 N to 1,500 N, preferably about 200 N to 500 N, and wherein channels (23) encircled by inner limiting surfaces (22) are arranged in said holding device (1).

### TECHNICAL FIELD

The present invention relates to a method and a device, respectively, for the attachment of cabling at a traction vehicle, which traction vehicle comprises a junction box for the connection of cabling to a trailer, or the like, wherein an holding device is arranged to position the cabling at a distance above the surfaces of the traction vehicle situated below the cabling.

### PRIOR ART

The traction vehicle is the most cost efficient freight solution for goods and therefore it is the most common carriage in Europe. The traction vehicle provides the trailer with electricity for lighting and compressed air for the brakes via, often helical, electric cables and air hoses. The appearance of these devices may be compared to telephone cords, where the number may vary but the most common is two or three electric cables and two air hoses.

When the carriage must take sharp turns in crossings or on loading yards, the position of the traction vehicle is often 45 to 60 degrees or more in relation to the trailer. Such occasions are most usual in densely built areas and in connection to loading and unloading. At these turns the cables and hoses are outstretched and will return to their idle positions when the carriage has been straightened out after the turn. The difference between an idle and an outstretched position is often 3.5 to 4 metres depending on the construction of the trailer. At such turns, the cables and hoses have a tendency to jam in each other and later on also to be tattered or to come loose after use during some time.

Another problem which arises at these sharp turns is that the cables and hoses draw the electric cables and the air connections in the lateral direction. After repeated stresses, the contacts may therefore be broken, or, as the hoses often are made of plastics, get a permanent fold. When an electric contact breaks, the trailer will miss lightening or the ABS function of the brakes will cease depending on which contact has broken.

When a fold has arisen on an air hose, the braking effect may be considerably reduced, i.e. the vehicle may not be braked with a normal braking effect as the air flow is hindered. After a short time the high air pressure, about 8 bars, will be able to burst a hole in the weakening (the fold) of the air hose. When the compressor cannot maintain the pressure because of a leakage, a completely uncontrolled disastrous braking will occur. This is a security function to prevent away-running vehicles in traffic.

Consequently, the vehicle is affected by a standstill, and, in the worst case, serious incidents may occur. The breakage may occur whenever and without any notice, (if the driver has not just braked and been aware of the reduced braking effect), which implies that the driver and fellow road-users cannot predict the danger. Serious incidents occur every year because of vehicles of different types running into stationary vehicles or carriages which are braking heavily depending on a hose rupture.

In addition, the haulier will be fined, should the vehicle miss its loading or unloading “slot” and in the worst case, he may lose the runs for his customer because of inadequate reliability. Further, there are extra costs for overtime and possible cars on duty. As a preventive measure, the hauliers change cables and hoses at a cost of thousands of Swedish crowns for each carriage and month. It may be mentioned that the third most common reason to ordering cars on duty in USA depends on hose fractures.

One of the greatest reasons for the problems with helical cables is that the attachments for the electric and air contacts have a low position on all traction vehicles, independent of manufacturer. This implies that the hoses hang down on the “catwalk”, i.e. the space between the traction vehicle and the trailer where the attachment device is arranged and where the driver stands at the connection of the trailer. Here, there are parts in which the cables may easily catch with the risk for cable fractures as a consequence.

Most hauliers/drivers try to solve the problems in their own cheap manners. A very usual manner is to attach elastic rubber straps, which are used for the securing of luggage, in the cabling and then to find a higher position somewhere on the cabin of the traction vehicle where there is a possibility to fasten a hook. This is a solution, which, in a cheap way, in certain cases may moderately offer a certain improvement but not with an entirely reliable result.

Another known solution, which is called “A-frame” is a solution, for which the haulier has to pay about SEK 5,000+mounting. Thus, a rather expensive solution. It is based on a tube construction with extendable cables and hoses, which raises the attachment positions by a considerable distance, whereby a desired, freely hanging connection of the hoses between traction vehicle and trailer is created.

A solution more of our days, known as “CableOne”, solves the problem by all cables and hoses being collected into one multi-cable, which is a long-lasting solution which effectively solves the problem, but which, however, is somewhat expensive, which implies that many drivers continue to choose cheap, non-reliable solutions.

Therefore, there is a demand for a better solution in the low-price class.

### DISCLOSURE OF THE INVENTION

An object of the present invention is to provide an improved solution at a comparatively low cost, which is achieved with a device and a method, respectively, at the attachment of cabling at a traction vehicles, which traction vehicle (5) comprises at least one junction box (7) for the connection of cabling (8) to a trailer (6), or the like, which method comprises that a holding device (1) is arranged to position the cabling at a distance above surfaces present below the cables (8), characterized in that said holding device (1) is attached at said traction vehicle (5) by non-destructive means (3).

This solution assists in a rapid, simple and chip manner to raise the level of the cabling at the traction vehicle, so that the risk of damage is essentially reduced. Thus, this is achieved in a surprisingly effective manner by the holder, collecting the existing cables and hoses, being attached to the cabin wall in a non-destructive manner by a magnetic force, for instance, which is strong enough to retain the cabling even at draws when the cabling is stretched at turns.

The invention offers i.a. the following advantages:
Principally suits all vehicles independent of manufacturer, as all producers use magnetic material in their cabin constructions.
No mechanical encroachments, for instance such as drilling or welding, in the cabin wall are needed.
Variable height position depending on requirement.
Low costs.
No loose or movable parts.
The own/existing cabling may be used.
Longer life of existing cabling.
Easy to mount.
May be mounted and demounted without tools.

According to further aspects, the additional advantage is:
That the cabling is collected and fixed by means of a lenient material.

### BRIEF DESCRIPTION OF DRAWINGS

The invention will below be described more in detail with reference to the enclosed drawings, of which:

FIG. 1 schematically shows a perspective view of a traction vehicle with a trailer which has been equipped with a device according to the invention;

FIG. 2 shows a perspective view from above of a first embodiment of a holding device according to the invention;

FIG. 3 shows a perspective view from below of the holding device according to FIG. 2; and

FIG. 4 shows a perspective view from below of another embodiment of a holding device according to the invention.

### DETAILED DESCRIPTION

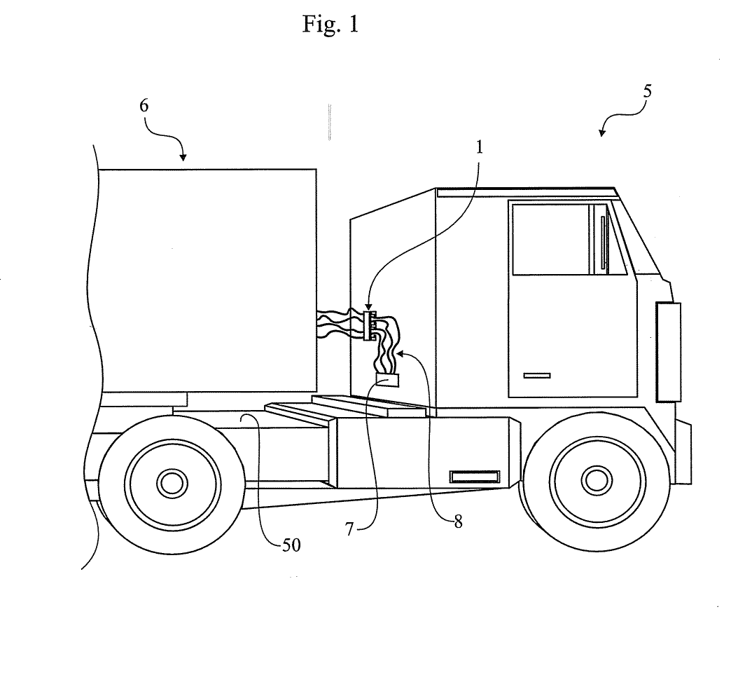

FIG. 1 shows a perspective view of a traction vehicle 5 to which a trailer 6 has been connected. At the traction vehicle 5 there is a junction box 7 for the connection of cabling 8 in order to provide the trailer with air and electricity. The figure shows that a holding device 1 according to the invention is arranged at the back of the cabin of the traction vehicle, preferably horizontally in a non-destructive manner (which will be explained more in detail below), so that the cabling 8 hangs at a safe distance above the surface 50 which has the shape of a platform and which extends rearwards at the traction vehicle 5. Thanks to this arrangement it is ensured that the cabling 8 is not damaged by being rubbed against the surface 50 or jammed in details arranged at or around this surface at the same time as it is ensured that a sufficient length is obtained so that the cabling may be able to flex enough in connection with turns.

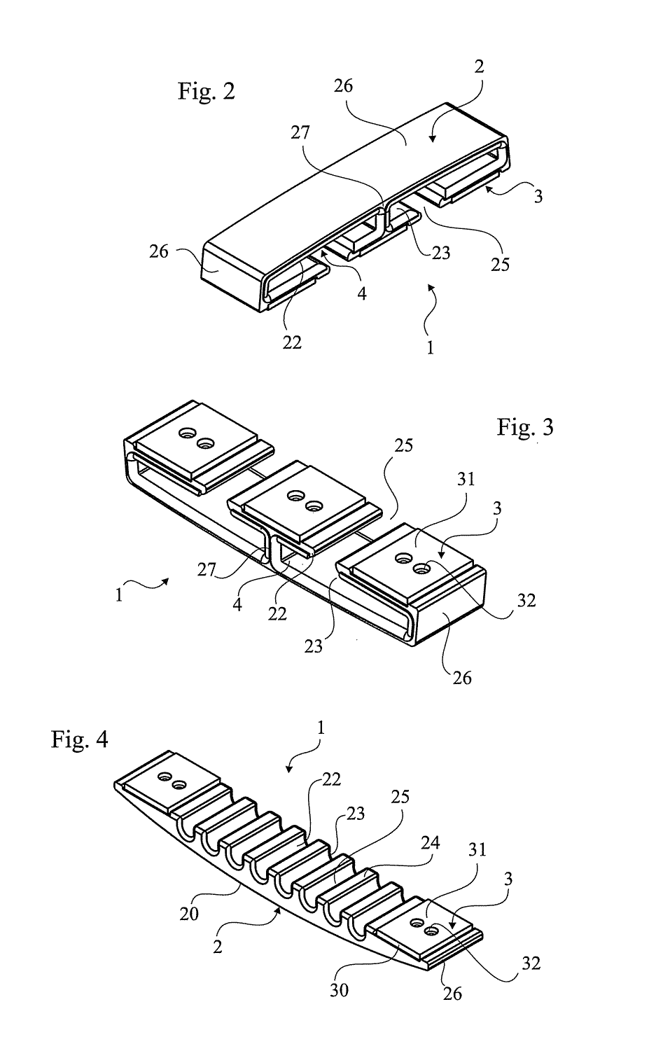

FIGS. 2 and 3 show a holding device 1 according to the invention, seen in perspective obliquely from above and obliquely from below, respectively. The holding device 1 comprises a body 2 with an outer upper side 20, two end walls 26 and a plurality of lower end surfaces 24, all essentially in the same plane. Between the upper end surface 20 and the lower end surface 24 there are channels 24, which are encircled by inner limiting surfaces 22. In the embodiment shown in FIGS. 2 and 3, two channels 23 are created by a partition wall 27 being centrally arranged and which at its lower end supports an intermediate lower surface 24. The last-mentioned surface 24 is arranged on a platform part which is centrally located at the end of said wall 27, so that tongues protrude in each direction at a right, or essentially right, angle in relation to the wall 27.

The end walls 26 extend essentially parallel to said partition wall 27, which end walls 26 are provided with corresponding tongues extending in a direction towards the partition wall and in the same plane as the platform part. Between the ends of the tongues, openings 25 are formed which are large enough to give space so that cabling may be inserted therein. Further, it is shown that a lenient material 4 is arranged in connection with the inwardly directed surfaces of the channels 23, which material 4 has the purpose to eliminate rubbing damages on cabling inserted into the channels 23.

The geometry of the holding device 1 is such that its width (seen in the extension of the cabling) is essentially larger than its length, wherein it preferably applies that the width is 2 to 5 times larger than its length (in the intended longitudinal direction of the cabling). In the normal case, the body 2 is suitably made so “long” that it will be easy to grip by hand, i.e. in the region of 30 to 100 mm, and suitably with a width in the region of 100 to 450 mm. As to height, the walls 26, 27 are arranged with a sufficient extension to accommodate normal sizes of cabling without any jamming occurring, which implies a gap of about 10 to 100 mm but preferably 30 to 60 mm. At the bottom surfaces 24, a number of magnetic plates 3 are arranged, preferably at each platform part, wherein the purpose of the magnets is to keep the holding device 1 safely towards a magnetic material. The magnetic plates 3 are arranged by means of screws, for instance, but, of course, also other methods may be used, such e.g. gluing, taping, riveting and/or welding.

The material used for the body 2 of the holding device 1 should have a good corrosion and erosion resistance, respectively, and may for instance be made of a suitable polymeric material or aluminium. Extrusion or moulding may suitably be used for the manufacture of the body 2, so that the costs may be kept at a low level, wherein extrusion often is to prefer, which in its turn implies that a configuration is preferred which enables extrusion, like what is shown in FIGS. 2 and 3.

In FIG. 4, an alternative embodiment is shown, where a body with dimensions as to length and width are used which are comparable to FIGS. 1 and 2, but instead of two large channels 23, a large number of small channels 23 are arranged parallelly, essentially in the longitudinal direction in accordance with what has previously been defined as the longitudinal direction. According to the embodiment, eight such channels 23 are shown, each of which shows an opening 25 in the lower surface 24 of the body 2. The width of the channels, which shall accommodate at least one cable, corresponds to approximately the thickness of the wall portions 27 extending between each pair of channels 23. The outer surface 20 is somewhat bent, in order to make the body 2 easier to grip. In this way, tapered portions are formed towards the ends 26. In connection to each end 26 there are lower, outer flat portions 24 with magnetic plates 3. It should be noticed that this embodiment does not use any additional (lenient) material between the body and the channels 23. This embodiment is suitably manufactured through moulding and of a polymeric material, so that round edge portions may be formed directly at the manufacture in a simple way and/or that a material which is lenient to the cabling may be used. However, if the material is not sufficiently lenient, when there are comparatively sharp edges, this embodiment may, of course, also be extruded.

The traction force from the magnets 3 is selected such that they give a traction force at the collaring against the vehicle which is in the region 100 N to 1,500 N, preferably about 200 N to 500 N, which according to tests performed show a sufficiently good retaining function for normal conceivable stresses while it enables a comparatively simple removal, which also is necessary in connection with exchange of trailers, etc.

The invention is not limited to the embodiments shown above but may be varied within the scope of the appending claims. A man skilled in the art realizes for instance that the size may in different ways be adapted to different kinds of situations/requirements and that different kinds of material combinations may be used as well as different types of designs and numbers of the channels, etc. As an example, it may be mentioned that a man skilled in the art knows that there are vehicles with several junction boxes and that these may be in the form of different types of junction boxes/casings/contacts/connections, which all are included in the expression junction boxes, for the sake of simplicity. The invention could also be provided with at least one, but preferably several hooks, catches or other fastening means, on which the helical cables may be hooked and hang with or without any need of arranging compartments or channels. In addition to this, a modification is included in the concept of the invention, where contacts for the cabling are arranged in the very body for the holding device 1, wherein the advantage is obtained that “straight” cables may be used from the exit of the traction vehicle to the holding device 1 and then only use the helical cabling between the holding device 1 and the trailer.

Further, it is realized that instead of plates for the magnets another configuration of the magnets may be used, such as for instance rod-shaped magnets which have been divided into the desired length and which for instance may imbedded in the desired place by casting in connection with the moulding and/or glued in place in cavities formed at the moulding and that also electro-magnets may be used. In its widest form, the invention may instead of magnets be provided with other non-destructive securing material such as e.g. suction plugs, tape, glue, which permit that the invention is mounted without tools.

1. A method for the attachment of cabling at a traction vehicle, which traction vehicle (5) comprises at least one junction box (7) for the connection of cabling (8) to a trailer (6), or the like, the method comprising:
arranging a holding device (1) to position the cabling at a distance above surfaces (50) situated below the cabling (8), wherein said holding device (1) is attached to said traction vehicle (5) by means of non-destructive means (3), and
arranging said non-destructive means (3) to give a retaining force of 100 N to 1,500 N, preferably about 200 N to 500 N, and wherein channels (23) encircled by inner limiting surfaces (22) are arranged in said holding device (1).

2. A method according to claim 1, wherein said non-destructive means (3) is one or more magnets.

3. A method according to claim 1 wherein said holding device (1) consists of a body (2) provided with an outer limiting surface (20) and an inner limiting surface (24) between which at least one channel (23) extends for part of or the entire cabling (8).

4. A method according to claim 3, wherein said body (2) is given a configuration which is adapted to continuous casting, extrusion and/or moulding.

5. A holding device for the attachment of cabling at a traction vehicle, the holding device (1) comprising:
a body (2) with securing means (3) arranged to position the cabling (8) at a distance above surfaces (50) situated below the cabling (8), wherein said securing means (3) is arranged to give a retaining effect by means of non-destructive means (3),
wherein said non-destructive means (3) is arranged to give a retaining force of 100 N to 1,500 N, preferably about 200 N to 500 N, and
wherein channels (23) encircled by inner limiting surfaces (22) are arranged in said holding device (1).

6. A holding device according to claim 5, wherein said nondestructive means (3) is one or more magnets.

7. A holding device according to claim 5, wherein said body (2) non-destructive means (3) is one or more magnets.

8. A holding device according to claim 5, wherein said body (2) has a comparatively compact geometry, which implies that no part of the body extends longer than 450 mm, preferably not longer than 300 mm.

9. A holding device according to claim 5, wherein said body (2) has at least one integrated channel (23), which is preferably 10 formed at the same time as the manufacture of the body (2).
